(19) United States
(12) Patent Application Publication
(10) Pub. No.: US 2021/0142414 A1
(43) Pub. Date: May 13, 2021

(54) MEASURE DETERMINATION SYSTEM, MEASURE DETERMINATION METHOD, AND MEASURE DETERMINATION PROGRAM

(71) Applicant: NEC Corporation, Minato-ku, Tokyo (JP)

(72) Inventor: Shinji ITO, Tokyo (JP)

(73) Assignee: NEC Corporation, Minato-ku, Tokyo (JP)

(21) Appl. No.: 17/054,262

(22) PCT Filed: May 14, 2018
(86) PCT No.: PCT/JP2018/018468

§ 371 Date: Nov. 10, 2020

(51) Int. Cl. G06Q 40/06; G06N 5/02

(52) U.S. Cl. CPC G06Q 40/06; G06N 5/02

(57) ABSTRACT

A measure determination system 80 determines a measure when an observed effect of the measure changes with time. An optimization unit 81 optimizes, based on the observed effect, an implementation ratio of the measure in such a manner as to maximize the effect to be multiplicatively accumulated. A reliability calculation unit 82 calculates, based on the optimized implementation ratio and the observed effect, reliability of each measure. A measure determination unit 83 determines a measure with higher reliability. An observation unit 84 observes an effect of the determined measure. The optimization unit 81 updates a past implementation ratio based on the observed effect, and the reliability calculation unit 82 updates the reliability of each measure based on the updated implementation ratio.

### TECHNICAL FIELD

The present invention relates to a measure determination system, a measure determination method, and a measure determination program that sequentially determine measures.

### BACKGROUND ART

There are situations in which maximizing the final reward is desired by sequentially repeating measures with uncertain effects. For this reason, various sequential decision-making methods have been proposed to maximize the reward by sequentially determining optimal measures.

For example, an expert algorithm (prediction with expert algorithm) is known as an example of a sequential decision-making method. In the expert algorithm, there are several prediction experts, and it is unclear which expert can be trusted, but it is assumed that the prediction results of all the experts can be confirmed. Here, which expert should be trusted for prediction problems to be sequentially presented is sequentially determined, and the expert to be selected next is further determined from the error with the prediction results.

PTL 1 discloses a multi-armed bandit problem (bandit algorithm) as another example of the sequential decision-making method. The multi-armed bandit problem is a general term for problems of sequentially trying in an appropriate order in consideration of the trade-off between a search for an easily-winning slot machine and a priority use of a winning slot machine in a plurality of slot machines whose winning rate is unknown in advance. The idea of the multi-armed bandit problem is also used in, for example, optimization of Web advertisement distribution whose effect is unknown until the advertisement is actually placed.

In addition, various methods for optimizing such a problem have been proposed. Online optimization is a method of determining a strategy xₜ at each time in such a manner that the value of a profit function fₜ(x) at each time t is to be larger. The profit function fₜ is unknown at the time of determining the strategy xₜ. That is, with the online optimization, the process for determining the strategy xₜ at each time and observing the profit function fₜ is sequentially repeated. Here, when the number of repetitions is T, the evaluation index is expressed as Expression 1 shown below. Note that, an effective algorithm is known under the assumption (convexity or the like) of the profit function fₜ.

[Math. 1]

Eₜ₌₁^{T}fₜ(xₜ) (Expression 1)

In addition, the Kelly's criterion is known as a criterion that represents the optimal investment ratio in the field of investment, and it is said that the optimal investment ratio can be calculated when there is one investee and the probability distribution of profit is simple and known. Note that, the index of optimality can be defined although there is a plurality of investees and the probability distribution is complicated, but an efficient algorithm for calculating the optimal investment ratio is not known.

In addition, PTL 2 discloses a decision-making assist system that assists a user in making a decision by estimating events that are expected to occur in the future in response to changing real situations. The system disclosed in PTL 2 analyzes information acquired via the Internet or the like, sequentially updates the event-causal relationship model according to the result, and provides the prediction results of events based on the latest information when a user makes a decision.

### CITATION LIST

### Patent Literature

PTL 1: Japanese Translation of PCT International Application Publication No. 2015-513154

PTL 2: Japanese Patent Application Laid-Open No. 2016-206914

### SUMMARY OF INVENTION

### Technical Problem

In the expert algorithm described above, the error between the prediction result of the selected expert and the prediction result of the optimal expert is the evaluation index, and the evaluation index is the cumulative error that is calculated additively. The above multi-armed bandit problem is also a model in which profits increase additively.

On the other hand, in a situation in which the effect of a measure changes with time, the effect of the measure can affect the profit not additively but multiplicatively. For example, in investment, when the ratio of an investee is determined for each unit period to maximize the profit in the future (for example, 10 years later), the effect (return ratio in investment) of the measure (investee) affects the profit multiplicatively. In addition, in, for example, marketing, a problem of maximizing the number of customers by improving efficiency while searching for effective campaigns is can be a problem that affects profits multiplicatively in consideration of the spread among customers due to the campaign (the spread due to word-of-mouth communication or the like).

When such a problem is generalized, it can be said that this is a problem in which decision making (decision of a measure) and observation of the result (observation of the effect of the measure) are repeated multiple times and the effect of the measure is multiplicatively observed.

However, when the effect of a measure affects the profit multiplicatively in this manner, the optimized result can be irrational if the expected value (average value) is simply maximized with a general method. Hereinafter, a situation in which the optimized result becomes irrational will be described with a specific example.

Now, the situation of investing in two investees A and B is exemplified. For the investee A, it is assumed that the profit becomes 1.3 times with the probability of 50% and that the profit becomes 0.9 times with the probability of 50%. Meanwhile, for the investee B, it is assumed that the profit becomes 2.0 times with the probability of 50% and that the profit becomes 0.4 times with the probability of 50%. Considering the average interest rate, the average interest rate of the investee A is 1.1 times, and the average interest rate of the investee B is 1.2 times. It can be considered that the investee B is superior when compared between the average interest rates.

On the other hand, it is assumed that the full amount is continuously invested in each investee. For example, in the case of continuously investing in the investee B 100 times, the assets will converge to 0. In other words, out of 100 investments, although the profit becomes 2.0 times about 50 times, the profit becomes 0.4 times about 50 times, that is, 2.0⁵⁰×0.4⁵⁰=(2.0×0.4)⁵⁰=0.8⁵⁰≈0. On the other hand, in the case of continuously investing in the investee B 100 times, the assets are expected to increase. In other words, out of 100 investments, the profit becomes 1.3 times about 50 times, and the profit becomes 0.9 times about 50 times, that is, 1.3⁵⁰×0.9⁵⁰=(1.3×0.9)⁵⁰=1.17⁵⁰≈2500.

In this manner, when the expected value is used as an evaluation index, it can be considered that the investment in the investee B is superior, but it can be said that the investment in the investee A is superior in a realistic sense. Thus, with the method for simply maximizing the expected value (average value), the result of the effect can be failure realistically.

PTL 2 discloses that the event-causal relationship model is sequentially updated to perform prediction, but does not specifically disclose the details thereof, and does not suppose the situation in which the effect of a measure affects the profit multiplicatively.

In view of the above, the present invention is to provide a measure determination system, a measure determination method, and a measure determination program capable of determining a measure that avoids a situation in which an optimized result becomes irrational and that maximizes the effect in a situation in which the effect of the measure to be sequentially implemented has multiplicative influence.

### Solution to Problem

A measure determination system according to the present invention is a measure determination system that determines a measure when an observed effect of the measure changes with time, the measure determination system including an optimization unit that optimizes, based on the observed effect, an implementation ratio of the measure in such a manner as to maximize the effect to be multiplicatively accumulated, a reliability calculation unit that calculates, based on the optimized implementation ratio and the observed effect, reliability of each measure, a measure determination unit that determines a measure with higher reliability, and an observation unit that observes an effect of the determined measure, in which the optimization unit updates, based on the observed effect, a past implementation ratio, and the reliability calculation unit updates, based on the updated implementation ratio, the reliability of the each measure.

A measure determination method according to the present invention is a measure determination method for determining a measure when an observed effect of the measure changes with time, the measure determination method including optimizing, based on the observed effect, an implementation ratio of the measure in such a manner as to maximize the effect to be multiplicatively accumulated, calculating, based on the optimized implementation ratio and the observed effect, reliability of each measure, determining a measure with higher reliability, observing an effect of the determined measure, updating, based on the observed effect, a past implementation ratio, updating, based on the updated implementation ratio, the reliability of the each measure and repeating determination of a measure, using the updated implementation ratio and the updated reliability.

A measure determination program according to the present invention is a measure determination program to be applied to a computer configured to determine a measure when an observed effect of the measure changes with time, the measure determination program causing the computer to execute an optimization process for optimizing, based on the observed effect, an implementation ratio of the measure in such a manner as to maximize the effect to be multiplicatively accumulated, a reliability calculation process for calculating, based on the optimized implementation ratio and the observed effect, reliability of each measure, a measure determination process for determining a measure with higher reliability, and an observation process for observing an effect of the determined measure, in which the optimization process includes updating, based on the observed effect, a past implementation ratio, and the reliability calculation process includes updating, based on the updated implementation ratio, the reliability of the each measure.

### Advantageous Effects of Invention

According to the present invention, it is possible to determine a measure that avoids a situation in which an optimized result becomes irrational and that maximizes the effect in a situation in which the effect of the measure to be sequentially implemented has multiplicative influence.

### BRIEF DESCRIPTION OF DRAWINGS

FIG. 1 It depicts a block diagram showing a measure determination system according to an exemplary embodiment of the present invention.

FIG. 2 It depicts an explanatory diagram showing an example of a measure determination process.

FIG. 3 It depicts a flowchart showing an operation example of the measure determination system.

FIG. 4 It depicts a flowchart showing an example of a process for calculating the reliability and the implementation ratio in the case of Type A.

FIG. 5 It depicts a flowchart showing an example of a process for calculating the reliability and the implementation ratio in the case of Type B.

FIG. 6 It depicts a block diagram showing an outline of the measure determination system according to the present invention.

FIG. 7 It depicts a schematic block diagram showing a configuration of a computer according to at least one exemplary embodiment of the present invention.

### DESCRIPTION OF EMBODIMENTS

Hereinafter, exemplary embodiments of the present invention will be described with reference to the drawings.

FIG. 1 is a block diagram showing a measure determination system according to an exemplary embodiment of the present invention. FIG. 2 is an explanatory diagram showing an example of a measure determination process assumed in the present invention. In the present invention, a process for sequentially determining a measure to be implemented from a plurality of measures and observing the effect of the determined measure or all the measures including the determined measure as a result is repeated. In the following description, the number of candidate measures is represented by d, and the number of decision makings is represented by T.

In the following description, investment in a plurality of assets (investees) is assumed as a specific example of a measure. In this case, the observed effect of the measure corresponds to the interest rate. Here, d represents the number of investees, and T corresponds to the number of rounds (the number of repeated investments).

In the flowchart of FIG. 2, first, a single asset (investee) and investment ratio are determined in each round, and investment is made (step S11). For example, when the investment ratio is expressed as xₜ=(xₜ₁, . . . x_{td}) ∈[0, 1]^{d}, and the investment ratio of the i-th investee is expressed as xₜᵢ, any one of xₜᵢ is xₜᵢ≤1, and the others are 0.

Then, the interest rate rₜ=(rₜᵢ, . . . , r_{td}) ∈ (−1, ∞)^{d} when the investment in each investee is made is observed (step S12). In the following, a case in which the interest rate rₜ of all investees can be observed (hereinafter, this case can be referred to as Type A), and a case in which only the interest rate rₜ of the investee in which investment is made can be observed (hereinafter, this case can be referred to as Type B) will be described. Here, rₜᵢ corresponds to the interest rate of the i-th investee.

As an example of a situation in which Type A is assumed, investment in stocks is included. For example, the situation is to observe, every Monday morning, the stock price fluctuation of each stock for the previous week and to change the own stock holding ratio. In addition, as an example of a situation in which Type B is assumed, the effect on the placement of Web advertisements, the effect on the investment in a certain research, or the like is included.

Hereinafter, the processes of steps S11 and S12 are repeated until the number of rounds T is satisfied.

As described above, if there is a plurality of measure candidates, the effects are observed by implementing the measures. However, if determination of a further measure is repeated in consideration of all the observation results, the number of elements to be considered is enormously increased, and it is impossible to manually perform the determination. Thus, by causing a computer to execute the following measure determination method according to the present invention, it is possible to sequentially determine measures in a realistic time.

FIG. 1 is a block diagram showing a configuration example of the measure determination system according to the present exemplary embodiment. A measure determination system 100 according to the present exemplary embodiment includes an input unit 10, a storage unit 20, a calculation unit 30, and an output unit 40. In the present exemplary embodiment, it is assumed that the effect of a measure changes with time. For example, in the case of investment, when an investment in a certain investee iₜ is regarded as a measure, the interest rate r, which is the effect, is information that changes with time.

The input unit 10 inputs the observed effect. The input unit 10 inputs, for example, the interest rate rₜ as the effect of the investment observed by the t-th time. Here, since the input unit 10 inputs the observed effect, it can be said to be an observation unit that observes the effect when the determined measure is implemented.

The storage unit 20 stores the observed effect of investment. The storage unit 20 sequentially stores, for example, the effect input to the input unit 10. The storage unit 20 may store the optimal implementation ratio x (investment ratio) and the reliability p of each measure (investment in an investee) calculated by the calculation unit 30 described later. The storage unit 20 is implemented by, for example, a magnetic disk or the like.

The calculation unit 30 includes an initialization unit 31, an optimization unit 32, a reliability calculation unit 33, and a measure determination unit 34.

The initialization unit 31 initializes the optimal investment ratio x=(x₁, x₂, . . . x_{d}) and the reliability of each asset (investee) p=(p₁, p₂, . . . p_{d}) used in the process described later. Each xᵢ(0≤xᵢ≤1) corresponds to the optimal investment ratio (ratio of the owned assets) in the case of investing in the i-th asset. In addition, each pᵢ(0≤p₁≤1) is a probability vector (however, p₁+p₂+ . . . +p_{d}=1) corresponding to the reliability of the i-th asset (investee) and indicates that the i-th asset is selected in each round with the probability pᵢ. As a result, the asset (investee) i corresponding to the largest pi is preferentially selected.

The optimization unit 32 optimizes, based on the observed effect, the implementation ratio of the measure in such a manner as to maximize the effect to be multiplicatively accumulated. Specifically, the optimization unit 32 calculates, based on the past interest rate r of each observed asset, the optimal investment ratio x of a certain investee iₜ in such a manner as to maximize the effect to be multiplicatively accumulated.

Here, the effect to be multiplicatively accumulated can be expressed as Expression 2 exemplified below when the final asset is A_{T}.

[Math. 2]

A_{T}=(1+r₁^{T}x₁)(1+r₂^{T}x₂) . . . =Πₜ₌₁^{T}(1+rₜ^{T}xₜ) (Expression 2)

However, as described above, if the expected value of A_{T} is simply maximized, the optimization result can be irrational (can be failure). Thus, in order to eliminate the possibility of such irrationality, the logarithmic log A_{T} of A_{T} is maximized. That is, Expression 2 exemplified above is transformed into Expression 3 exemplified below.

[Math. 3]

A_{T}=log(1+r₁^{T}x₁)+log(1+r₂^{T}x₂)+ . . . =Σₜ₌₁^{T} log(1+rₜ^{T}xₜ) (Expression 3)

The expected value of log A_{T} is a more rational index than the expected value of A_{T}. In the following, the reason will be described by taking the situation of investing in the above two investees A and B as an example. Now, it is assumed that (xₜ)^{T}ₜ₌₁=(Xₜ⁽¹⁾, Xₜ⁽²⁾)^{T}ₜ₌₁ is a Bernoulli random variable, Prob[Xₜ⁽¹⁾=1.3]=Prob[Xₜ⁽¹⁾=0.9]=½, and Prob[Xₜ⁽²⁾=2.0]=Prob[Xₜ⁽¹⁾=0.5]=½. In addition, it is assumed that xₜ and X_{t′}are independent random variables of t≠t′. Here, it is not assumed that Xₜ⁽¹⁾ and Xₜ⁽²⁾ are independent.

Here, the respective final assets A_{T}⁽¹⁾ and assets A_{T}⁽²⁾ are defined as Expressions 4 and 5 shown below, respectively.

[Math. 4]

A_{T}⁽¹⁾=Πₜ₌₁^{T}Xₜ⁽¹⁾ (Expression 4)

A_{T}⁽²⁾=Πₜ₌₁^{T}Xₜ⁽²⁾ (Expression 5)

Since the expected value E[Xₜ⁽¹⁾]=1.1 and the expected value E[Xₜ⁽²⁾]=1.2, the final expected value E[A_{T}⁽¹⁾] is expressed as E[A_{T}⁽¹⁾]=1.1^{T}<E[A_{T}⁽²⁾]=1.2^{T}. This means that A_{T}⁽²⁾ is preferable to A_{T}⁽¹⁾ in the case of making decisions based on the expected value. However, taking each probability into consideration, it can be shown that lim_{T}→∞A_{T}⁽¹⁾=∞ and lim_{T}→∞A_{T}⁽²⁾=0.

In fact, when Expression 6 exemplified below is the product of independent and identically distributed random variables, Expression 7 exemplified below is obtained. Note that, the last equal sign in Expression 7 is obtained from the law of large numbers.

[Math. 5]

A_{T}=Πₜ₌₁^{T} (Expression 6)

$${lim}_{T \to ∞} {( {A}_{T} )}^{\frac{1}{T}} = exp ( {lim}_{T \to ∞} \frac{1}{T} {\sum }_{t = 1}^{T} log {X}_{t} ) = exp ( E [ log {X}_{1} ] ) \qquad ( Expression 7 )$$

By applying Expressions 4 and 5 to Expression 7, Expression 8 shown below is obtained.

$$[ Math . 6 ]$$

$${lim}_{T \to ∞} {( {A}_{T}^{( 2 )} )}^{\frac{1}{T}} < 1 < {lim}_{T \to ∞} {( {A}_{T}^{( 1 )} )}^{\frac{1}{T}} \qquad ( Expression 8 )$$

In general, when Expressions 4 and 5 are products of independent and identically distributed random variables, E[log X₁⁽¹⁾]>E[log X₁⁽²⁾] holds only if Expression shown below 9 is satisfied.

[Math. 7]

limₜ₌₁^{T}A_{T}⁽¹⁾/Aₜ⁽²⁾=∞ (Expression 9)

The above suggests that it is rational to compare the logarithms of rewards when the events that occur with high probability in the multiplicative (reward) model are focused on.

In this manner, by the optimization unit 32 performing optimization using a more rational index, it is possible to determine a more appropriate measure. In addition, by reducing the optimization target to an additive model when the effect to be multiplicatively accumulated is maximized as described above, it is possible to use a general optimization method.

The optimization unit 32 may calculate the optimal investment ratio x for the additive model described above by using, for example, online convex optimization. Since the method of online convex optimization is widely known, detailed description is omitted.

Then, the optimization unit 32 updates the past investment ratio with the calculated investment ratio. That is, the optimization unit 32 updates, based on the observed effect (for example, interest rate r), the past implementation ratio (for example, investment ratio x).

The reliability calculation unit 33 calculates, based on the optimized implementation ratio and the observed effect, the reliability of each measure. Specifically, the reliability calculation unit 33 calculates, based on the investment ratio x and the past interest rate r of each asset, the reliability p of each investee iₜ. Note that, similarly to the optimization unit 32, the reliability calculation unit 33 uses a logarithm (specifically, logA_{T} in Expression 3) as an index to calculate the reliability without using a simple effect (expected value). That is, the reliability calculation unit 33 calculates, based on the effect represented by the logarithm, the reliability of each measure.

The method for the reliability calculation unit 33 to calculate the reliability is determined according to the range of the observable effect. Specifically, the reliability calculation unit 33 may select a method for calculating the reliability according to the case in which the effect of all the measures can be observed (that is, the case of Type A) and the case in which the effect of only the implemented measure can be observed (that is, the case of Type B).

When the effect of all the measures can be observed (that is, the case of Type A), the reliability calculation unit 33 may calculate the reliability based on the expert algorithm. Alternatively, when the effect of only the determined measure can be observed (that is, the case of Type B), the reliability calculation unit 33 may calculate the reliability based on the bandit algorithm.

Then, the reliability calculation unit 33 updates the reliability of each measure with the calculated reliability. That is, the reliability calculation unit 33 updates, based on the sequentially updated implementation ratio (for example, the investment ratio x), the reliability p of each investee.

The measure determination unit 34 determines a measure with higher reliability. Specifically, the measure determination unit 34 determines an investee iₜ having higher reliability p.

The output unit 40 outputs the details of the determined measure. The output unit 40 outputs, for example, the investee iₜ₊₁ and the investment ratio xₜ₊₁ as the details of the t+1-th measure.

The input unit 10, the calculation unit 30 (more specifically, the initialization unit 31, the optimization unit 32, the reliability calculation unit 33, and the measure determination unit 34), and the output unit 40 are implemented by a processor (for example, a central processing unit (CPU), or a graphics processing unit (GPU), a field-programmable gate array (FPGA)) of a computer that operates according to a program (measure determination program).

For example, the program may be stored in the storage unit 20, and the processor may load the program and operate, according to the program, as the input unit 10, the calculation unit 30 (more specifically, the initialization unit 31, the optimization unit 32, the reliability calculation unit 33, and the measure determination unit 34), and the output unit 40. In addition, the function of the measure determination system may be provided in the Software as a Service (SaaS) format.

The initialization unit 31, the optimization unit 32, the reliability calculation unit 33, and the measure determination unit 34 may be independently implemented by dedicated hardware. In addition, a part of or all of the constituent elements of each device are implemented by a general purpose or dedicated circuitry, a processor, or the like, or a combination thereof. These may be constituted by a single chip, or by a plurality of chips connected via a bus. A part of or all of the constituent elements of each device may be implemented by a combination of the above circuitry or the like and a program.

In the case in which a part of or all of the constituent elements of the measure determination system are implemented by a plurality of information processing devices, circuitries, or the like, the information processing devices, circuitries, or the like may be arranged in a concentrated manner, or dispersedly. For example, the information processing devices, circuitries, or the like may be implemented as a form in which each is connected via a communication network, such as a client-server system, a cloud computing system, or the like.

Next, the operation of the measure determination system in the present exemplary embodiment will be described. FIG. 3 is a flowchart showing an operation example of the measure determination system in the present exemplary embodiment. The initialization unit 31 initializes the value t for counting the number of measures to 1 (step S21). The initialization unit 31 further initializes the implementation ratio x and the reliability p (step S22). The measure determination unit 34 determines a measure iₜ based on the probability p indicating the reliability (step S23). Note that, the value of the reliability p is indefinite in the initial state, and any measure iₜ may be determined. Then, the output unit 40 outputs the determined measure iₜ and the corresponding implementation ratio xᵢₜ (step S24).

The input unit 10 observes and inputs the effect rₜ of the measure (step S25). The optimization unit 32 optimizes, based on the observed effects, the implementation ratio of the measure and updates the past implementation ratio x (step S26). The reliability calculation unit 33 calculates, based on the optimized implementation ratio x and the observed effect rₜ, the reliability of each measure and updates the reliability of each measure (step S27).

The initialization unit 31 updates the value oft to be incremented by 1 (step S28). If the value oft is not equal to or greater than the number of decision makings T (No in step S29), the processes of step S23 and subsequent steps are repeated. On the other hand, when the value of t is equal to or greater than T (Yes in step S29), the process is terminated.

Next, a method for calculating the reliability and the implementation ratio will be specifically described for each type. For convenience of description, some notations are defined. First, [d] is a set of at least positive integers of d, that is, [d]={1, 2, . . . , d}. In addition, fₜᵢ:[0,1]→R is defined as Expression 10 shown below. Here, C₁ is a constant that satisfies C₁>−1.

fₜᵢ(x)=log(1+rₜᵢx)−log(1+C₁) (Expression 10)

In addition, it is assumed that C₂≥C₁, rₜᵢ ∈[C₁, C₂] and C₁≤0, Expression 11 shown below holds for x ∈[0, 1].

$$[ Math . 8 ]$$

$$0 \leq {f}_{ti} ( x ) \leq log \frac{1 + {C}_{2}}{1 + {C}_{1}} \text{=:} {C}_{4} \qquad ( Expression 11 )$$

Furthermore, for all t ∈[T] and i ∈[d], Expressions 12 and 13 shown below are defined. These values are used to update x.

$$[ Math . 9 ]$$

$$\begin{matrix}{g}_{ti} = \frac{d}{dx} {f}_{ti} ( {x}_{ti} ) = \frac{{r}_{ti}}{1 + {r}_{ti} {x}_{ti}} & ( Expression 12 ) \\ {h}_{ti} = min \{ \frac{1}{{( 1 + {C}_{1} )}^{2}} , {( 1 + {C}_{2} )}^{2} \} {g}_{ti}^{2} = {C}_{3} {g}_{ti}^{2} & ( Expression 13 )\end{matrix}$$

Furthermore, it is assumed that the value hₜᵢ is the upper limit of Expression 14 shown below.

[Math. 10]

C₃ max{C₁², C₂²}/(1+C₁)² (Expression 14)

Here, hₜᵢ is the boundary of the second derivative of fₜᵢ(x). Specifically, Expression 15 shown below is satisfied for all x ∈[0, 1].

$$[ Math . 11 ]$$

$$\frac{{d}^{2}}{{dx}^{2}} {f}_{ti} ( x ) = - \frac{{r}_{ti}^{2}}{{( 1 + {r}_{ti} x )}^{2}} = - \frac{{r}_{ti}^{2}}{{( 1 + {r}_{ti} {x}_{ti} )}^{2}} \cdot \frac{{( 1 + {r}_{ti} {x}_{ti} )}^{2}}{{( 1 + {r}_{ti} x )}^{2}} \leq - {g}_{ti}^{2} \cdot {C}_{3} = - {h}_{ti} \qquad ( Expression 15 )$$

Expression 15 shows the details of Expression 16 shown below. The inequality sign in Expression 16 serves as an important role.

[Math. 12]

fₜᵢ(x)≤fₜᵢ(xₜᵢ)+gₜᵢ(x−xₜᵢ)−½hₜᵢ(x−xₜᵢ)² (Expression 16)

In addition, it is assumed that i* and x* represent the optimal strategy in T trials. That is, this optimal strategy can be expressed as Expression 17 shown below.

$$[ Math . 13 ]$$

$$( {i}^{*} , {x}^{*} ) ∈ {arg max}_{( i , x ) ∈ [ d ] \times [ 0 , 1 ]} {\sum }_{t = 1}^{T} log ( 1 + {r}_{ti} x ) = {arg max}_{( i , x ) ∈ [ d ] \times [ 0 , 1 ]} {\sum }_{t = 1}^{T} {f}_{ti} ( x ) \qquad ( Expression 17 )$$

Here, Fₜ*=fₜᵢ* (x*) is defined for all t ∈ [T]. In addition, Fₜᵢ=fₜᵢ(xₜᵢ) is defined for all t ∈[T] and i ∈[d]. At this time, the regret can be expressed as Expression 18 shown below. In Expression 18, iₜ and xₜ represent output in processing.

$$[ Math . 14 ]$$

$${R}_{T} = {\sum }_{t = 1}^{T} {f}_{ti} * ( {x}^{*} ) - {\sum }_{t = 1}^{T} {f}_{{ti}_{t}} ( {x}_{t} ) = {\sum }_{t = 1}^{T} {F}_{t}^{*} - {\sum }_{t = 1}^{T} {F}_{ti} \qquad ( Expression 18 )$$

First, the case of Type A will be described. Type A is a method for calculating the optimal implementation ratio x based on the online convex optimization and calculating the reliability p of each measure based on the expert algorithm. FIG. 4 is a flowchart showing an example of a process for calculating the reliability and the implementation ratio in the case of Type A. The initialization unit 31 initializes w and x to w₁=[w₁₁, . . . w_{1d}]^{T}=1 (a vector in which all elements are 1) and x₁=[x₁₁, . . . x_{1d}]^{T}=0 (a vector in which all elements are 0) (step S31).

The reliability calculation unit 33 sets the reliability pₜ to pₜ=wₜ/∥wₜ∥1 (step S32). The measure determination unit 34 randomly selects a measure iₜ based on the probability vector pₜ (step S33). The output unit 40 outputs the measures iₜ and xₜ=xₜᵢₜ, and the input unit 10 observes the effect rₜᵢ of all the measures (step S34).

The optimization unit 32 updates wₜ (step S35). Specifically, the optimization unit 32 sets wₜ₊₁ to w_{t+1,i}=wₜᵢexp(ηFₜᵢ) for i. Note that, η is a positive parameter. In addition, the optimization unit 32 updates xₜ (step S36). Specifically, the optimization unit 32 sets xₜ₊₁ to a value calculated with Expression 19 shown below.

In Expression 19, π_{[0,4]}(·) represents the projection on [0,1]. That is, regarding π_{[0,1]}(y), π_{[0,1]}](y)=0 for y<0, and π_{[0,1]}(y) for 0≤y≤1=y, and π_{[0,1]}(y)=1 for y>1. In Expression 19, B is a positive parameter.

$$[ Math . 15 ]$$

$${x}_{t + 1 , i} ∈ {arg max}_{x ∈ [ 0 , 1 ]} \{ {\sum }_{j = 1}^{t} ( {g}_{ji} ( x - {x}_{ji} ) - \frac{1}{2} {{h}_{ji} ( x - {x}_{ji} )}^{2} ) - \frac{1}{2} {Bx}^{2} \} = {π}_{[ 0 , 1 ]} ( \frac{{\sum }_{j = 1}^{t} {g}_{ji}}{B + {\sum }_{j = 1}^{t} {h}_{ji}} ) \qquad ( Expression 19 )$$

Thereafter, the processes of steps S32 to S36 are repeated until the number of trials reaches T.

Next, the case of Type B will be described. Type B is a method for calculating the optimal implementation ratio x based on the online convex optimization and calculating the reliability p of each measure based on the bandit algorithm. FIG. 5 is a flowchart showing an example of a process for calculating the reliability and the implementation ratio in the case of Type B. In the process of Type B, the unbiased estimators g\hat{ }ₜᵢ and h\hat{ }ₜᵢ for gₜᵢ and hₜᵢ are set as shown Expression 20 below (where \hat{ } represents a superscript hat).

$$[ Math . 16 ]$$

$$( {\hat{g}}_{ti} , {\hat{h}}_{ti} ) = \{ \begin{matrix}( \frac{{g}_{ti}}{{p}_{ti}} , \frac{{h}_{ti}}{{p}_{ti}} ) & if i = {i}_{t} , \\ ( 0 , 0 ) & otherwise\end{matrix} \qquad ( Expression 20 )$$

Similarly to Type A, the initialization unit 31 initializes w and x to w₁=[w₁₁, . . . w_{1d}]^{T}=1 (a vector in which all elements are 1) and x₁=x₁=[x₁₁, . . . x_{1d}]^{T}=0 (a vector in which all elements are 0) (step S41). The reliability calculation unit 33 sets the reliability pₜ as shown in Expression 21 below (step S42)

$$[ Math . 17 ]$$

$$\frac{γ}{d} 1 + ( 1 - γ ) \frac{{w}_{t}}{{‖ {w}_{t} ‖}_{1}} ∈ {ℝ}^{d} \qquad ( Expression 21 )$$

The measure determination unit 34 randomly selects a measure iₜ based on the probability vector pₜ (step S43). The output unit 40 outputs the measure iₜ and xₜ=xₜᵢₜ, and the input unit 10 observes the effect rₜᵢₜ of only the selected measure (step S44).

The optimization unit 32 updates wₜ (step S45). Specifically, the optimization unit 32 sets w_{t+1,it}=wₜᵢₜexp(ηFₜᵢₜ/pₜᵢₜ) for wₜ and sets w_{t+1,i}=wₜᵢ for i≠ₜ. In addition, the optimization unit 32 updates xₜ (step S46). Specifically, the optimization unit 32 sets xₜ₊₁ to a value calculated with Expression 22 shown below.

$$[ Math . 18 ]$$

$${x}_{t + 1 , i} ∈ {arg max}_{x ∈ [ 0 , 1 ]} \{ {\sum }_{j = 1}^{t} ( {\hat{g}}_{ji} ( x - {x}_{ji} ) - \frac{1}{2} {{\hat{h}}_{ji} ( x - {x}_{ji} )}^{2} ) - \frac{1}{2} {Bx}^{2} \} = {π}_{[ 0 , 1 ]} ( \frac{{\sum }_{j = 1}^{t} {\hat{g}}_{ji}}{B + {\sum }_{j = 1}^{t} {\hat{h}}_{ji}} ) \qquad ( Expression 22 )$$

Thereafter, the processes of steps S42 to S46 are repeated until the number of trials reaches T.

As described above, in the present exemplary embodiment, the optimization unit 32 optimizes, based on the observed effect, the implementation ratio of the measure in such a manner as to maximize the effect to be multiplicatively accumulated, and the reliability calculation unit 33 calculates, based on the optimized implementation ratio and the observed effect, the reliability of each measure. The measure determination unit 34 determines a measure with higher reliability, and the input unit 10 observes the effect of the determined measure. The optimization unit 32 updates a past implementation ratio based on the observed effect, and the reliability calculation unit 33 updates the reliability of each measure based on the updated implementation ratio. This investment ratio and reliability are sequentially updated based on the observed effect, and a measure is determined. Thus, it is possible to determine a measure that avoids a situation in which an optimized result becomes irrational and that maximizes the effect in a situation in which the effect of the measure to be sequentially implemented has multiplicative influence.

Next, an outline of the present invention will be described. FIG. 6 is a block diagram showing an outline of the measure determination system according to the present invention. The measure determination system according to the present invention is a measure determination system 80 (for example, the measure determination system 100) that determines a measure (for example, an investment in a certain investee iₜ) when an observed effect (for example, the interest rate r) of the measure changes with time.

The measure determination system 80 includes an optimization unit 81 (for example, the optimization unit 32) that optimizes, based on the observed effect (for example, the interest rate r of each investee), an implementation ratio (for example, the investment ratio x) of a measure (for example, investment in a certain investee iₜ) in such a manner as to maximize the effect to be multiplicatively accumulated, a reliability calculation unit 82 (for example, the reliability calculation unit 33) that calculates, based on the optimized implementation ratio and the observed effect, reliability (for example, the reliability p) of each measure (for example, the investee iₜ in which investment is to be made), a measure determination unit 83 (for example, the measure determination unit 34) that determines a measure (for example, the investee iₜ) with higher reliability, and an observation unit 84 (for example, the input unit 10) that observes an effect of the determined measure.

The optimization unit 81 updates a past implementation ratio based on the observed effect, and the reliability calculation unit 82 updates the reliability of each measure based on the updated implementation ratio.

With such a configuration, it is possible to determine a measure that avoids a situation in which an optimized result becomes irrational and that maximizes the effect in a situation in which the effect of measures to be sequentially implemented has multiplicative influence.

Specifically, the optimization unit 81 may optimize the implementation ratio based on online convex optimization, and the reliability calculation unit 82 may calculate the reliability of each measure based on an expert algorithm. With such a configuration, when the effect of all the measures can be observed (for example, in the case of Type A), it is possible to calculate the optimal implementation ratio and reliability of each measure.

In addition, the optimization unit 81 may optimize the implementation ratio based on online convex optimization, and the reliability calculation unit 82 may calculate the reliability of each measure based on a bandit algorithm. With such a configuration, when the effect of only the determined measure can be observed (for example, in the case of Type B), it is possible to calculate the optimal implementation ratio and reliability of each measure.

As a specific aspect, the optimization unit 81 may optimize a ratio of investment in an investee based on the observed interest rate of each asset, the reliability calculation unit 82 may calculate reliability of each investee based on the optimized ratio of investment and the observed interest rate of each asset, and the measure determination unit 83 may determine an investment in an investee with higher reliability as a measure.

In addition, the optimization unit 81 may transform the effect to be multiplicatively accumulated into an additive effect represented by a logarithm (such as Expression 3 shown above) and optimize the implementation ratio of the measures in such a manner as to maximize the effect represented by the logarithm, and the reliability calculation unit 82 may calculate the reliability of each measure based on the effect represented by the logarithm.

FIG. 7 is a schematic block diagram showing a configuration of a computer according to at least one exemplary embodiment of the present invention. A computer 1000 includes a processor 1001, a main storage device 1002, an auxiliary storage device 1003, and an interface 1004.

The above measure determination system is implemented in the computer 1000. Then, the operation of each processing unit described above is stored in the auxiliary storage device 1003 in the form of a program (measure determination program). The processor 1001 loads the program from the auxiliary storage device 1003, develops the program in the main storage device 1002, and executes the above processes in accordance with the program.

Note that, in at least one exemplary embodiment, the auxiliary storage device 1003 is an example of a non-transitory tangible medium. Other examples of the non-transitory tangible medium include a magnetic disk, a magneto-optical disk, a compact disc read-only memory (CD-ROM), a digital versatile disc read-only memory (DVD-ROM), and a semiconductor memory that are connected via the interface 1004. Furthermore, when this program is distributed to the computer 1000 through a communication line, the computer 1000 receiving the distribution may develop the program in the main storage device 1002 and execute the above processes.

The program may be for implementing a part of the functions described above. Furthermore, the program may be implemented in combination with another program already stored in the auxiliary storage device 1003, that is, what is called a difference file (difference program).

Note that, a part or all of the above exemplary embodiments can also be described as follows, but are not limited to the following.
(Supplementary Note 1)

A measure determination system configured to determine a measure when an observed effect of the measure changes with time, the measure determination system including:

an optimization unit configured to optimize, based on the observed effect, an implementation ratio of the measure in such a manner as to maximize the effect to be multiplicatively accumulated;

a reliability calculation unit configured to calculate, based on the optimized implementation ratio and the observed effect, reliability of each measure;

a measure determination unit configured to determine a measure with higher reliability; and

an observation unit configured to observe an effect of the determined measure, in which the optimization unit is configured to update, based on the observed effect, a past implementation ratio, and

the reliability calculation unit is configured to update, based on the updated implementation ratio, the reliability of the each measure.
(Supplementary Note 2)

The measure determination system according to Supplementary note 1, in which

the optimization unit is configured to optimize the implementation ratio based on online convex optimization, and

the reliability calculation unit is configured to calculate the reliability of the each measure based on an expert algorithm.

### (Supplementary Note 3)

The measure determination system according to Supplementary note 1, in which

the optimization unit is configured to optimize the implementation ratio based on online convex optimization, and

the reliability calculation unit configured to calculate the reliability of the each measure based on a bandit algorithm.
(Supplementary Note 4)

The measure determination system according to any one of Supplementary notes 1 to 3, in which

the optimization unit is configured to optimize, based on an observed interest rate of each asset, a ratio of investment in an investee,

the reliability calculation unit is configured to calculate, based on the optimized ratio of investment and the observed interest rate of the each asset, reliability of each investee, and

the measure determination unit is configured to determine an investment in an investee with higher reliability as a measure.
(Supplementary Note 5)

The measure determination system according to any one of Supplementary notes 1 to 4, in which

the optimization unit is configured to transform the effect to be multiplicatively accumulated into an additive effect represented by a logarithm and optimize the implementation ratio of the measure in such a manner as to maximize the effect represented by the logarithm, and

the reliability calculation unit is configured to calculate, based on the effect represented by the logarithm, the reliability of the each measure.
(Supplementary Note 6)

A measure determination method for determining a measure when an observed effect of the measure changes with time, the measure determination method including:

optimizing, based on the observed effect, an implementation ratio of the measure in such a manner as to maximize the effect to be multiplicatively accumulated;

calculating, based on the optimized implementation ratio and the observed effect, reliability of each measure;

determining a measure with higher reliability;

observing an effect of the determined measure;

updating, based on the observed effect, a past implementation ratio;

updating, based on the updated implementation ratio, the reliability of the each measure; and

repeating determination of a measure, using the updated implementation ratio and the updated reliability.
(Supplementary Note 7)

The measure determination method according to Supplementary note 6, further including:

optimizing the implementation ratio based on online convex optimization; and

calculating the reliability of the each measure based on an expert algorithm.
(Supplementary Note 8)

The measure determination method according to Supplementary note 6, further including:

optimizing the implementation ratio based on online convex optimization; and

calculating the reliability of the each measure based on a bandit algorithm.
(Supplementary Note 9)

A measure determination program to be applied to a computer configured to determine a measure when an observed effect of the measure changes with time, the measure determination program causing the computer to execute:

an optimization process for optimizing, based on the observed effect, an implementation ratio of the measure in such a manner as to maximize the effect to be multiplicatively accumulated;

a reliability calculation process for calculating, based on the optimized implementation ratio and the observed effect, reliability of each measure;

a measure determination process for determining a measure with higher reliability; and

an observation process for observing an effect of the determined measure, in which

the optimization process includes updating, based on the observed effect, a past implementation ratio, and

the reliability calculation process includes updating, based on the updated implementation ratio, the reliability of the each measure.
(Supplementary Note 10)

The measure determination program according to Supplementary note 9, in which

the optimization process includes optimizing, by the computer, the implementation ratio based on online convex optimization, and

the reliability calculation process includes calculating, by the computer, the reliability of the each measure based on an expert algorithm.
(Supplementary Note 11)

The measure determination program according to Supplementary note 9, in which

the optimization process includes optimizing, by the computer, the implementation ratio based on online convex optimization, and

the reliability calculation process includes calculating, by the computer, the reliability of the each measure based on a bandit algorithm.

### REFERENCE SIGNS LIST

10 Input unit
20 Storage unit
30 Computation unit
31 Initialization unit
32 Optimization unit
33 Reliability calculation unit
34 Measure determination unit
40 Output unit

What is claimed is:

1. A measure determination system configured to determine a measure when an observed effect of the measure changes with time, the measure determination system comprising a hardware processor configured to execute a software code to:
optimize, based on the observed effect, an implementation ratio of the measure in such a manner as to maximize the effect to be multiplicatively accumulated;
calculate, based on the optimized implementation ratio and the observed effect, reliability of each measure;
determine a measure with higher reliability;
observe an effect of the determined measure;
update, based on the observed effect, a past implementation ratio; and
update, based on the updated implementation ratio, the reliability of the each measure.

2. The measure determination system according to claim 1, wherein the hardware processor is configured to execute a software code to:
optimize the implementation ratio based on online convex optimization; and
calculate the reliability of the each measure based on an expert algorithm.

3. The measure determination system according to claim 1, wherein the hardware processor is configured to execute a software code to:
optimize the implementation ratio based on online convex optimization; and
calculate the reliability of the each measure based on a bandit algorithm.

4. The measure determination system according to claim 1, wherein the hardware processor is configured to execute a software code to:
optimize, based on an observed interest rate of each asset, a ratio of investment in an investee;
calculate, based on the optimized ratio of investment and the observed interest rate of the each asset, reliability of each investee; and
determine an investment in an investee with higher reliability as a measure.

5. The measure determination system according to claim 1 wherein the hardware processor is configured to execute a software code to:
transform the effect to be multiplicatively accumulated into an additive effect represented by a logarithm and optimize the implementation ratio of the measure in such a manner as to maximize the effect represented by the logarithm; and
calculate, based on the effect represented by the logarithm, the reliability of the each measure.

6. A measure determination method for determining a measure when an observed effect of the measure changes with time, the measure determination method comprising:
optimizing, based on the observed effect, an implementation ratio of the measure in such a manner as to maximize the effect to be multiplicatively accumulated;
calculating, based on the optimized implementation ratio and the observed effect, reliability of each measure;
determining a measure with higher reliability;
observing an effect of the determined measure;
updating, based on the observed effect, a past implementation ratio;
updating, based on the updated implementation ratio, the reliability of the each measure; and
repeating determination of a measure, using the updated implementation ratio and the updated reliability.

7. The measure determination method according to claim 6, further comprising:
optimizing the implementation ratio based on online convex optimization; and
calculating the reliability of the each measure based on an expert algorithm.

8. The measure determination method according to claim 6, further comprising:
optimizing the implementation ratio based on online convex optimization; and
calculating the reliability of the each measure based on a bandit algorithm.

9. A non-transitory computer readable information recording medium storing a measure determination program to be applied to a computer configured to determine a measure when an observed effect of the measure changes with time, when executed by a processor, the measure determination program performs a method for:
optimizing, based on the observed effect, an implementation ratio of the measure in such a manner as to maximize the effect to be multiplicatively accumulated;
calculating, based on the optimized implementation ratio and the observed effect, reliability of each measure;
determining a measure with higher reliability;
observing an effect of the determined measure;
updating, based on the observed effect, a past implementation measure; and
updating, based on the updated implementation ratio, the reliability of the each measure.

10. The non-transitory computer readable information recording medium according to claim 9, further comprising:
optimizing the implementation ratio based on online convex optimization; and
calculating the reliability of the each measure based on an expert algorithm.

11. The non-transitory computer readable information recording medium according to claim 9, further comprising:
optimizing the implementation ratio based on online convex optimization; and
calculating the reliability of the each measure based on a bandit algorithm.
